(19) United States
(12) Patent Application Publication
(10) Pub. No.: US 2015/0149178 A1
(43) Pub. Date: May 28, 2015

(54) SYSTEM AND METHOD FOR DATA-DRIVEN INTONATION GENERATION

(71) Applicant: AT&T Intellectual Property I, L.P., Atlanta, GA (US)

(72) Inventors: Yeon-Jun KIM, Whippany, NJ (US); Mark Charles BEUTNAGEL, Mendham, NJ (US); Alistair D. CONKIE, Morristown, NJ (US); Taniya MISHRA, New York, NY (US)

(73) Assignee: AT&T Intellectual Property I, L.P., Atlanta, GA (US)

(21) Appl. No.: 14/087,840

(22) Filed: Nov. 22, 2013

(51) Int. Cl. G10L 13/02

(52) U.S. Cl. CPC G10L 13/02
USPC 704/260

(57) ABSTRACT

Systems, methods, and computer-readable storage media for text-to-speech processing having an improved intonation. The system first receives text to be converted to speech, the text having a first segment and a second segment. The system then compares the text to a database of stored utterances, identifying in the database a first utterance corresponding to the first segment and determining an intonation of the first utterance. When the database does not contain a second utterance corresponding to the second segment, the system generates the speech corresponding to the text by combining the first utterance with a generated second utterance corresponding to the second segment, the generated second utterance having the intonation matching, or based on, the first utterance. These actions lead to an improved, smoother, more human-like synthetic speech output from the system.

### BACKGROUND

1. Technical Field

The present disclosure relates to text-to-speech generation and more specifically to providing human-like speech by intonation generation.

2. Introduction

A text-to-speech system converts text into spoken output using pre-recorded human speech, usually in small segments of speech called phonemes. While multiple ways exist to determine which pre-recorded human speech is selected for text, the central concept is matching phonemes corresponding to the text with phonemes found in a database. Databases of speech can be differentiated based on domains, themes, genders of speakers, accents, or other desired qualities. Such distinct collections of recorded speech allow for a more natural and human-like synthetic voice to be produced.

### BRIEF DESCRIPTION OF THE DRAWINGS

FIG. 1 illustrates an example system embodiment;

FIG. 2 illustrates an example system configuration of data-driven intonation generation;

FIG. 3 illustrates an example of data-driven intonation generation; and

FIG. 4 illustrates an example method embodiment.

### DETAILED DESCRIPTION

A system, method and computer-readable media are disclosed which receive text for the purpose of generating speech from the text having an improved intonation. The system first receives text to be converted to speech, the text having a first segment and a second segment. The system then compares the text to a database of stored utterances, identifying in the database a first utterance corresponding to the first segment and determining an intonation of the first utterance. When the database does not contain a second utterance corresponding to the second segment, the system generates the speech corresponding to the text by combining the first utterance with a generated second utterance corresponding to the second segment, the generated second utterance having the intonation matching, or based on, the first utterance. These actions lead to an improved, smoother, more human-like synthetic speech output from the system.

When identifying pre-recorded speech and generating unfound speech, the system produces output speech where the pieces of speech are selected and generated based at least in part on the tone, or intonation, of the speech. The system, instead of averaging intonation parameters, can search the database using the best intonation parameters of available speech and/or the most desired intonation parameters determined from the text being converted. In addition to intonation parameters, the system can also search for candidate words using tags, target costs, join costs, and/or a prosody phrase.

As an example, the system, upon receiving text, can first search the database of pre-recorded speech for words which are labeled with syntactically similar tags, such as tags for various parts of speech. Exemplary tags could be <verb>, <noun>, <coordinating conjunction>, <pronoun>, or other syntactically related parts of speech. Such a search produces candidate words in a similar breathing group or prosody phrase. Using these candidate words, the system constructs a lattice, then seeks to minimize both target costs and join costs for a series of the candidate words. Finally, the intonation of the best path is copied and used to generate speech corresponding to any missing words, resulting in a speech output where the words have a matching intonation.

The intonation of the best path identified can require identifying context, emotion, gender, domain, pitch, utterance speed, and/or tone of the words in the candidate word lattice. The lattice itself can increase or be expanded as the system searches a database for each word in the text. For example, if the system searches for the text “My dog Sam,” the system may initially conduct a search for “My”, and upon finding candidate pre-recorded versions of “My” generate a lattice of those candidates. The various candidates corresponding to a single word, such as “My,” can be due to distinct speakers, topics, domains, accents, speed, pitch, tone, prosody, and/or other phonetic distinctions. If only a single version of the searched for word is found, the system can still place the word into a lattice. The system can then search for “dog”, adding “dog” candidates found in the database to the lattice containing the “My” candidates, and continue with “Sam” candidates.

Selecting the best path, particularly when there are multiple candidates of any single word, can be based on reducing join costs and target costs between the words, and matching intonation between words as best as possible. To identify intonations which are similar, the system can score the pitch, speed, tone, and/or prosody of the individual words seeking compatibility. Such scores can be calculated over the period of time associated with the word to generate a slope corresponding to an initial score (head score) and a final score (tail score) for each word. As an alternative to scores, the words can be categories into intonation categories, such as Serious, Neutral, Angry, Questioning, Male, Female, Loud, Soft, etc. Words can be assigned to a single category or to multiple categories. When the words have a similarity in scores/categories above a similarity threshold, the system recognizes the words as having a similar intonation. In circumstances where the scores are below a rejection threshold, the system recognizes that such a combination is undesirable. Intonation similarity, join cost, and/or target cost can be used to determine the best path of candidate words found in the pre-recorded speech database.

For example, when calculating join costs, one formula the system can use is:

Join Cost(A,B)=|slope(A,body)−slope(B,head)|+|slope(A,tail)−(slope(B,body)|

where Slope(A, body) is defined as the fundamental slope of the word, i.e., the slope of word A as it progresses from head to tail, based on average frequencies, volume, and/or other sound metrics. The slope can refer to the shift in tone as a word is spoken, such as a down-step when the tone shifts within any metric, such as from a high tone to a low tone. If the metric were emphasis, then the slope could refer to sliding emphasis within the sounds detected. Slope(A, head) is the fundamental slope of the word immediately previous to word A, and Slope(A, tail) is the fundamental slope of the word immediately following word A. Slope(A) can include not only the fundamental slope of word A, but also the median value of the A's slope from head to tail.

The target cost can be based on both a category of the words and/or intonation of the words. For example, costs associated with a particular domain or topic, such as weather, can have a distinct cost from other domains and/or topics, such as automobiles. Distances between topics, domains, and other categories can be pre-calculated in a table. The table of distances can be manually generated or automatically developed as the system collects additional data/utterances. Whereas the join cost can identify a difference in combining two words based on phonetic parameters, the target cost identifies a difference in combining distinct categories of words.

The system can operate in manual or automatic configurations. Consider the following example of manually selecting the best intonation. A user needs an audio clip saying “Hello, thank you for calling XYZ corporation,” to be played as a call center greeting message many times per day. Quality of the speech output is critical, and therefore the user desires the clip to sound as human-like as possible. Because text-to-speech processing is used for most other dialog with callers, for consistency the greeting will use the same text-to-speech voice.

The user views the current contents of the text-to-speech system audio recordings. While this exact phrase was not recorded, sentence-initial “Hello” occurs 8 times and “thank you for calling” occurs 4 times, and sentence-final “corporation” occurs twice. Listening to the database instances, user selects one version of “Hello” and catalogs it with the name tag [HELLO 1]. Likewise, the favored version of “thank you for calling” is cataloged with name tag [THANKCALLING1], and the two versions of “corporation” as [CORP1] and [CORP2].

Returning to the text display, the user highlights “Hello” and specifies that the HELLO1 audio units should be selected. Likewise, user highlights “thank you for calling” and “corporation,” and selects THANKCALLING1 and CORP1, respectively. After listening, user reselects CORP2, which sounds better. The default rendering of “XYZ” is acceptable, so the audio clip is saved for use by the dialog application.

When a word or phrase in the text is not located in the pre-recorded speech database, the system seeks to match the intonation of the surrounding words when generating the missing word. For example, as the system plays the candidate words corresponding to the best path found in the lattice, the system encounters a “missing word” which was not found in the database of pre-recorded words. The system identifies candidate phonemes based on the text, then selects between the candidate phonemes when outputting synthetic speech in such a way as to match the intonation of the best path speech. Alternatively, the system can modify candidate phonemes to match the intonation of the speech by compressing, extending, or otherwise modifying a time of play associated with the individual phonemes to make the intonation of the generated “missing” word match the best path words. In addition to time modifications, the system can raise or lower pitch, modify volume, tone, or other descriptive characteristics of the phonemes being used for the generated missing word.

In certain configurations, the prosody/intonation of the missing word can be imported from speech of the user. In such configurations, the user's recording of the text, or a subset of the user's recording, can be transplanted onto the phonemes generated by the text-to-speech system via a text analysis module. Then, in future instances where the word is generated by the system, the intonation and prosody of the user will be used as guidance in generating the missing word.

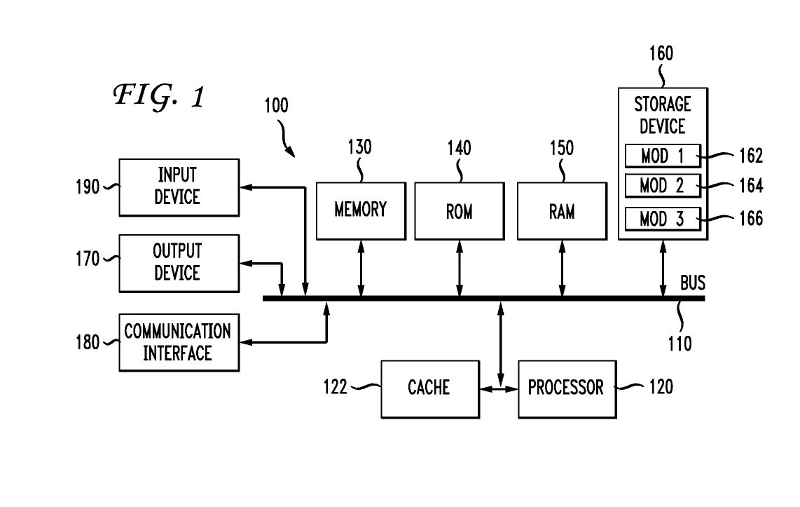

Various embodiments of the disclosure are described in detail below. While specific implementations are described, it should be understood that this is done for illustration purposes only. Other components and configurations may be used without parting from the spirit and scope of the disclosure. A brief introductory description of a basic general purpose system or computing device in FIG. 1 which can be employed to practice the concepts, methods, and techniques disclosed is illustrated. A more detailed description of data driven intonation generation will then follow, accompanied by various embodiments. The disclosure now turns to FIG. 1.

With reference to FIG. 1, an exemplary system and/or computing device 100 includes a processing unit (CPU or processor) 120 and a system bus 110 that couples various system components including the system memory 130 such as read only memory (ROM) 140 and random access memory (RAM) 150 to the processor 120. The system 100 can include a cache 122 of high speed memory connected directly with, in close proximity to, or integrated as part of the processor 120. The system 100 copies data from the memory 130 and/or the storage device 160 to the cache 122 for quick access by the processor 120. In this way, the cache provides a performance boost that avoids processor 120 delays while waiting for data. These and other modules can control or be configured to control the processor 120 to perform various actions. Other system memory 130 may be available for use as well. The memory 130 can include multiple different types of memory with different performance characteristics. It can be appreciated that the disclosure may operate on a computing device 100 with more than one processor 120 or on a group or cluster of computing devices networked together to provide greater processing capability. The processor 120 can include any general purpose processor and a hardware module or software module, such as module 1 162, module 2 164, and module 3 166 stored in storage device 160, configured to control the processor 120 as well as a special-purpose processor where software instructions are incorporated into the processor. The processor 120 may be a self-contained computing system, containing multiple cores or processors, a bus, memory controller, cache, etc. A multi-core processor may be symmetric or asymmetric.

The system bus 110 may be any of several types of bus structures including a memory bus or memory controller, a peripheral bus, and a local bus using any of a variety of bus architectures. A basic input/output (BIOS) stored in ROM 140 or the like, may provide the basic routine that helps to transfer information between elements within the computing device 100, such as during start-up. The computing device 100 further includes storage devices 160 such as a hard disk drive, a magnetic disk drive, an optical disk drive, tape drive or the like. The storage device 160 can include software modules 162, 164, 166 for controlling the processor 120. The system 100 can include other hardware or software modules. The storage device 160 is connected to the system bus 110 by a drive interface. The drives and the associated computer-readable storage media provide nonvolatile storage of computer-readable instructions, data structures, program modules and other data for the computing device 100. In one aspect, a hardware module that performs a particular function includes the software component stored in a tangible computer-readable storage medium in connection with the necessary hardware components, such as the processor 120, bus 110, display 170, and so forth, to carry out a particular function. In another aspect, the system can use a processor and computer-readable storage medium to store instructions which, when executed by the processor, cause the processor to perform a method or other specific actions. The basic components and appropriate variations can be modified depending on the type of device, such as whether the device 100 is a small, handheld computing device, a desktop computer, or a computer server.

Although the exemplary embodiment(s) described herein employs the hard disk 160, other types of computer-readable media which can store data that are accessible by a computer, such as magnetic cassettes, flash memory cards, digital versatile disks, cartridges, random access memories (RAMs) 150, read only memory (ROM) 140, a cable or wireless signal containing a bit stream and the like, may also be used in the exemplary operating environment. Tangible computer-readable storage media, computer-readable storage devices, or computer-readable memory devices, expressly exclude media such as transitory waves, energy, carrier signals, electromagnetic waves, and signals per se.

To enable user interaction with the computing device 100, an input device 190 represents any number of input mechanisms, such as a microphone for speech, a touch-sensitive screen for gesture or graphical input, keyboard, mouse, motion input, speech and so forth. An output device 170 can also be one or more of a number of output mechanisms known to those of skill in the art. In some instances, multimodal systems enable a user to provide multiple types of input to communicate with the computing device 100. The communications interface 180 generally governs and manages the user input and system output. There is no restriction on operating on any particular hardware arrangement and therefore the basic hardware depicted may easily be substituted for improved hardware or firmware arrangements as they are developed.

For clarity of explanation, the illustrative system embodiment is presented as including individual functional blocks including functional blocks labeled as a “processor” or processor 120. The functions these blocks represent may be provided through the use of either shared or dedicated hardware, including, but not limited to, hardware capable of executing software and hardware, such as a processor 120, that is purpose-built to operate as an equivalent to software executing on a general purpose processor. For example the functions of one or more processors presented in FIG. 1 may be provided by a single shared processor or multiple processors. (Use of the term “processor” should not be construed to refer exclusively to hardware capable of executing software.) Illustrative embodiments may include microprocessor and/or digital signal processor (DSP) hardware, read-only memory (ROM) 140 for storing software performing the operations described below, and random access memory (RAM) 150 for storing results. Very large scale integration (VLSI) hardware embodiments, as well as custom VLSI circuitry in combination with a general purpose DSP circuit, may also be provided.

The logical operations of the various embodiments are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits. The system 100 shown in FIG. 1 can practice all or part of the recited methods, can be a part of the recited systems, and/or can operate according to instructions in the recited tangible computer-readable storage media. Such logical operations can be implemented as modules configured to control the processor 120 to perform particular functions according to the programming of the module. For example, FIG. 1 illustrates three modules Mod1 162, Mod2 164 and Mod3 166 which are modules configured to control the processor 120. These modules may be stored on the storage device 160 and loaded into RAM 150 or memory 130 at runtime or may be stored in other computer-readable memory locations.

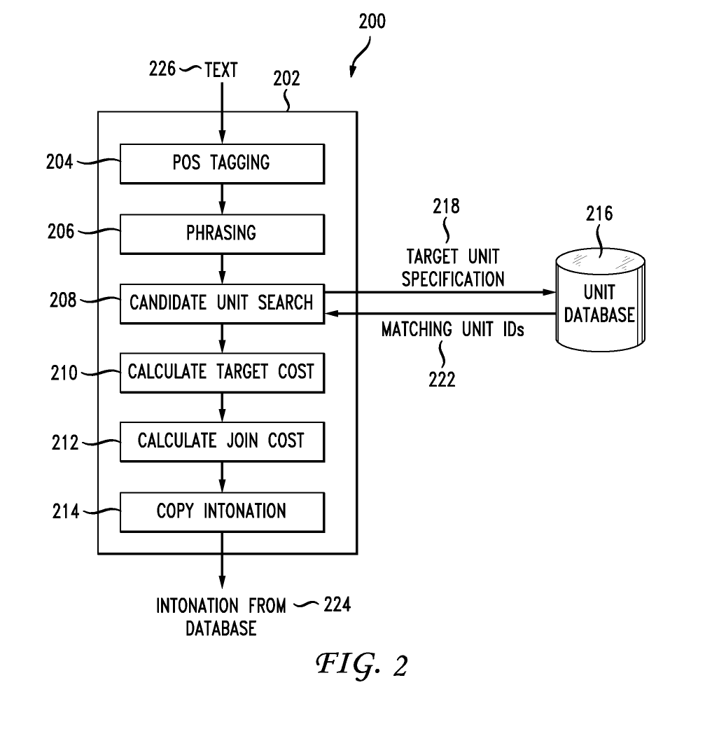

Having disclosed some components of a computing system, the disclosure now turns to FIG. 2, which illustrates an example system configuration of data-driven intonation generation. In this example 200, a text-to-speech system 202 receives text 226. The system 202 first tags the text 226 based on parts of speech 204. Exemplary tags can be <verb>, <noun>, <pronoun>, <coordinating conjunction>, etc., or can be specific to the circumstances of the word. For example, the parts of speech tagging 204 could be specific to location of a word in a sentence, phrase, or paragraph. Examples of such location/grammatical specific tagging could be <sentence-initial>, <sentence-final>, <before-comma>, <before-semicolon>, <before-exclamation>, etc.

Upon tagging the parts of speech, 204, the system 202 identifies connected phrases. Such connections can be based on the location of punctuation throughout the text 226, or can be based on certain words (such as coordinating conjunctions “and,” “or,” “but,” etc.). Common phrases can also be identified by a user, or through statistics indicating repetition of words. For example, the system 202 might recognize “What time is it” as a common phrase, whereas “What time is it in Mexico” might not be common. In such circumstances, the system 202, at the phrasing identification 206, can identify portions of text which can be clustered together.

Having tagged parts of speech 204 and clustered text by phrases 206, the system 202 performs a candidate unit search 208 for pre-recorded words matching the text. In performing the candidate unit search 208, the system sends target unit specifications 218 to a unit database 216 having a collection of pre-recorded utterances. The target unit specifications 218 can contain the text of desired words and/or phrases in addition to the parts of speech tags identified during parts of speech tagging 204. The unit database 216 sends back to the system 202 matching unit identifications 222 corresponding to pre-recorded speech matching the target unit specifications 218. The candidate unit search 208, upon receiving the matching unit identifications 222, builds a lattice of candidate words and phrases found in the unit database 216. The lattice constructed can list not only the words, but also characteristics of the words, such as tone, speed, emotion, individual intonation, etc., as values in the lattice.

The system 202 then calculates a target cost 210 for generating the speech based, at least in part, on the lattice of candidate words. The target cost calculated 210 can be a target cost for generating speech using candidate words, the calculation can include factors such as the categories of the words, distinct styles of the words, and how many words are to be combined to accurately represent the text 226 received. In certain cases, the target cost can be influenced by processing requirements. For example, a processor might only be capable of producing speech when the target costs remain below a target cost threshold. In other instances, the exceeding the target cost threshold might produce excessive latency or require closing other programs/applications/threads, all of which are undesirable.

Having calculated target costs 210, the system 202 calculates join costs 212 for combining the candidate words in the candidate word lattice. Join costs, determined in part on the differences in the candidate words, can be excessively high when the words are dissimilar and/or when the words have distinct intonations/tone slopes. Using the join costs, the system 202 determines a best path through the lattice, where the best path represents candidate words which, when combined together, have a join cost within the target cost threshold and meeting any other parameters (such as emotion, gender, tone) desired. The join costs for specific parameters can be predefined prior to calculating target costs and join costs. For example, the join costs for parameters associated with a particular context of an utterance, an emotion, a gender, a pitch, an utterance speed, and/or a tone can be stored in a database prior to the target cost and join cost calculations. In addition, the system 202 can record the intonation 214 in a database prior to calculating joint/target costs.

With the best path determined, the system 202 can copy the intonation 214 of the best path prior to generating additional speech. The copied intonation can then be used to either generate speech having a combination of phonemes with the same intonation as the best path, or can be used to find additional speech having the desired best path intonation from a database 224.

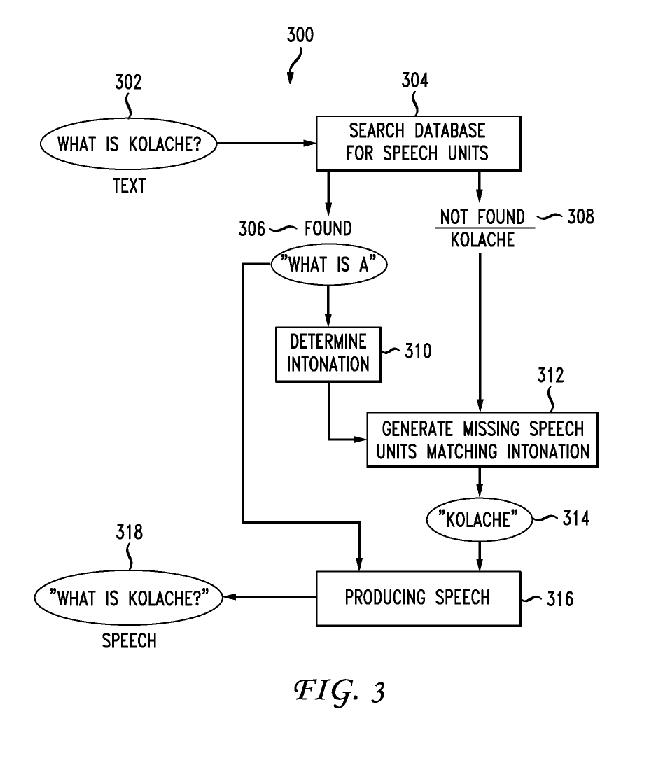

FIG. 3 illustrates an example of data-driven intonation generation 300. In this example, the system receives text 302 which is to be used in generating corresponding speech. In our example, the text received is “What is a kolache?” A kolache is a delicious Slovak treat having grown in popularity in parts of the southwestern United States. The system searches the pre-recorded speech database for candidate speech units 304 and finds “What is a” 306. However, the database does not contain “kolache” 308. The system determines the intonation 310 of the found words 306, then generates missing speech units 312 to match the intonation of the found words. Now the generated “kolache” 314 will be similar in tone and prosody to the “What is a” 306 found in the pre-recorded database. The system then produces speech 316 using the found speech 306 “What is a” plus the generated speech units 314 “kolache,” the final result being speech output 318 of “What is a kolache?” Because “kolache” was generated using speech units selected to match the intonation of the found speech units “What is a,” the final speech output 318 should have a human-like intonation. In addition, because of the question mark contained in the original text 302, the system will produce speech having a shift in tone corresponding to human shifts when a question is presented.

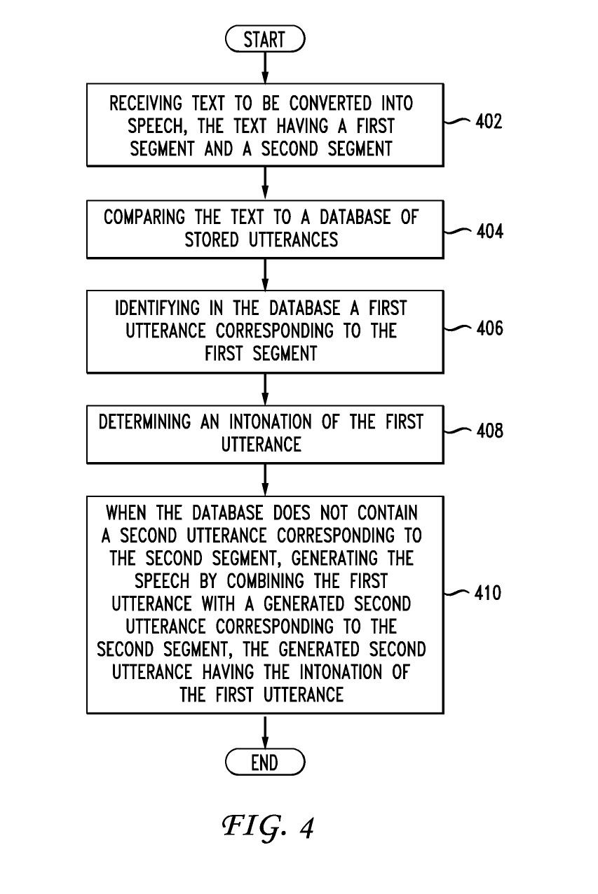

Having disclosed some basic system components and concepts, the disclosure now turns to the exemplary method embodiment shown in FIG. 4. For the sake of clarity, the method is described in terms of an exemplary system 100 as shown in FIG. 1 configured to practice the method. The steps outlined herein are exemplary and can be implemented in any combination thereof, including combinations that exclude, add, or modify certain steps.

The system 100 receives text to be converted into speech, the text having a first segment and a second segment (402). The first and second segments can be characters, words, phrases, sentences, paragraphs, and/or other text components. The system 100 can analyze the text, tagging parts of speech in the text, tagging specific words in the text based on position in their respective clauses/sentences/paragraphs, tagging punctuation or emotion, or tagging specific parts of grammar such as punctuation. The system 100 can also cluster words from the text together based on phrases, which can be identified based on punctuation or based on a list of common phrases.

The system 100 then compares the text to a database of stored utterances (404). The database of pre-recorded utterances can be a module within the system 100, can be external to the system 100, or can be connected to the system 100 via a network connection such as the Internet. The database of stored utterances has pre-recorded voice recordings which the system 100 can use to output speech corresponding to the text. The pre-recorded voice recordings stored in the database can be originally spoken (and subsequently recorded) by a human being, or can be synthetically generated and recorded by a machine. The recordings can be categories using various parameters including gender, tone, frequency of specific vibrations in the recording, duration, accents associated with the recording, and/or emotion. The recordings can also have additional parameters, such as a timestamp indicating when the recording was made, in what context the recording was made, and references to preceding and/or following responses. Other parameters which can be stored are which portion of a sentence or paragraph (such as “Hello” being the first word in a sentence, or “Goodbye” being the last word in a paragraph) the word corresponds to, or the types of utterances being recorded (for example, questions, exclamations, clarifying, etc.).

The system 100 can perform the comparing by sending specifications to the database regarding the text. Such specifications can include features identified in the text, punctuation, phonemes associated with the text, or any parameters identified in the text which might also be stored in the database of recorded utterances (such as accent, duration, emotion, etc.). The database can then indicate, by sending identifications of stored voice recordings, which text segments of the text have corresponding recordings stored in the database. From the identifications, the system 100 can identify a first utterance corresponding to the first segment of text (406) and determine an intonation of the first utterance (408). The intonation of the first utterance can be based on the tone, a shift in tone, a prosody, a duration, a gender, an emotion, a pitch, or other characteristics of the found speech units identified in the database. When determining the intonation of the first utterance (408), the system 100 can be configured such that the first segment occurs prior to the second segment, after the second segment, or both before and after the segment (i.e., if the database has a speech segment with a “hole” in it.). The first utterance can also apply to a best path of utterances determined using join cost and target cost from available candidate utterances in the database.

When the database includes multiple instances of stored utterances corresponding to the second segment, the system 100 can select an instance for the second utterance from the multiple instances based on a join cost, a target cost, and the intonation. When the database does not contain a second utterance corresponding to the second segment, the system 100 generates speech corresponding to the text received by combining the first utterance with a generated second utterance corresponding to the second segment, the generated second utterance having the intonation matching, or based on, the first utterance (410). For example, if the database does not contain a particular word found in the text, the system 100 determines the intonation of the words which are found in the database, then matches the intonation of the words which are found when generating the text not found in the database. Matching the intonation can occur by modifying phonemes selected such that the found utterance and generated words of the segment not found are not disjointed when played. The system 100 can determine if the words will be disjointed when there is a difference in tone, pitch, or other intonation category greater than a threshold value. The system 100 can repeat the phoneme modification process iteratively until the phonemes to be used for the generated utterance have an intonation matching (i.e., within a threshold distance) of the speech utterances which are found in the pre-recorded speech database.

Embodiments within the scope of the present disclosure may also include tangible and/or non-transitory computer-readable storage media for carrying or having computer-executable instructions or data structures stored thereon. Such tangible computer-readable storage media can be any available media that can be accessed by a general purpose or special purpose computer, including the functional design of any special purpose processor as described above. By way of example, and not limitation, such tangible computer-readable media can include RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various embodiments described above are provided by way of illustration only and should not be construed to limit the scope of the disclosure. For example, the principles herein apply to using data to match intonation, and can be used for a single word or phrases being generated. Various modifications and changes may be made to the principles described herein without following the example embodiments and applications illustrated and described herein, and without departing from the spirit and scope of the disclosure. Claim language reciting “at least one of” a set indicates that one member of the set or multiple members of the set satisfy the claim.

We claim:

1. A method comprising:
receiving text to be converted into speech, the text comprising a first segment and a second segment;
comparing the text to a database of stored utterances;
identifying in the database a first utterance corresponding to the first segment;
determining, via a processor, an intonation of the first utterance; and
when the database does not contain a second utterance corresponding to the second segment, generating the speech by combining the first utterance with a generated second utterance corresponding to the second segment, the generated second utterance having the intonation of the first utterance.

2. The method of claim 1, wherein determining the intonation of the first utterance further comprises identifying in the stored utterance one of a context, an emotion, a gender, a pitch, an utterance speed, and a tone.

3. The method of claim 2, further comprising:
when the database comprises multiple instances of stored utterances corresponding to the second segment:
selecting an instance for the second utterance from the multiple instances based on a join cost, a target cost, and the intonation.

4. The method of claim 1, further comprising tagging the text prior to comparing the text to the database of stored utterances, wherein the tagging is based upon parts of speech found in the text.

5. The method of claim 1, wherein identifying the first utterance further comprises finding a best path of speech units from candidate speech units in the database.

6. The method of claim 5, wherein the intonation is recorded in the database, after which the best path is determined based on a target cost and a join cost calculated using the candidate speech units.

7. The method of claim 1, wherein comparing of the text to the database of stored utterances further comprises sending target unit specifications to the database.

8. A system comprising:
a processor; and
a computer-readable storage medium having instruction stored which, when executed by the processor, cause the processor to perform operations comprising:
receiving text to be converted into speech, the text comprising a first segment and a second segment;
comparing the text to a database of stored utterances;
identifying in the database a first utterance corresponding to the first segment;
determining an intonation of the first utterance; and
when the database does not contain a second utterance corresponding to the second segment, generating the speech by combining the first utterance with a generated second utterance corresponding to the second segment, the generated second utterance having the intonation of the first utterance.

9. The system of claim 8, wherein determining the intonation of the first utterance further comprises identifying in the stored utterance one of a context, an emotion, a gender, a pitch, an utterance speed, and a tone.

10. The system of claim 9, the computer-readable storage medium having additional instructions stored which result in the operations further comprising:
when the database comprises multiple instances of stored utterances corresponding to the second segment:
selecting an instance for the second utterance from the multiple instances based on a join cost, a target cost, and the intonation.

11. The system of claim 8, the computer-readable storage medium having additional instructions stored which result in the operations further comprising tagging the text prior to comparing the text to the database of stored utterances, wherein the tagging is based upon parts of speech found in the text.

12. The system of claim 8, wherein identifying the first utterance further comprises finding a best path of speech units from candidate speech units in the database.

13. The system of claim 12, wherein the intonation is recorded in the database, after which the best path is determined based on a target cost and a join cost calculated using the candidate speech units.

14. The system of claim 8, wherein comparing of the text to the database of stored utterances further comprises sending target unit specifications to the database.

15. A computer-readable storage device having instruction stored which, when executed by a computing device, cause the computing device to perform operations comprising:
receiving text to be converted into speech, the text comprising a first segment and a second segment;
comparing the text to a database of stored utterances;
identifying in the database a first utterance corresponding to the first segment;
determining an intonation of the first utterance; and
when the database does not contain a second utterance corresponding to the second segment, generating the speech by combining the first utterance with a generated second utterance corresponding to the second segment, the generated second utterance having the intonation of the first utterance.

16. The computer-readable storage device of claim 15, wherein determining the intonation of the first utterance further comprises identifying in the stored utterance one of a context, an emotion, a gender, a pitch, an utterance speed, and a tone.

17. The computer-readable storage device of claim 16 having additional instructions stored which result in the operations further comprising:
when the database comprises multiple instances of stored utterances corresponding to the second segment:
selecting an instance for the second utterance from the multiple instances based on a join cost, a target cost, and the intonation.

18. The computer-readable storage device of claim 16 having additional instructions stored which result in the operations further comprising tagging the text prior to comparing the text to the database of stored utterances, wherein the tagging is based upon parts of speech found in the text.

19. The computer-readable storage device of claim 16, wherein identifying the first utterance further comprises finding a best path of speech units from candidate speech units in the database.

20. The computer-readable storage device of claim 19, wherein the intonation is recorded in the database, after which the best path is determined based on a target cost and a join cost calculated using the candidate speech units.
